(19) United States
(12) Patent Application Publication
(10) Pub. No.: US 2007/0031706 A1
(43) Pub. Date: Feb. 8, 2007

(54) Method for producing magnetic recording medium and magnetic recording medium

(75) Inventors: Shuichi Okawa, Tokyo (JP); Kazuhiro Hattori, Tokyo (JP); Takahiro Suwa, Tokyo (JP); Mitsuru Takai, Tokyo (JP)

Correspondence Address: OLIFF & BERRIDGE, PLC, P.O. BOX 19928, ALEXANDRIA, VA, 22320, US

(73) Assignee: TTDK CORPORATION, Tokyo (JP)

(21) Appl. No.: 10/555,670

(22) PCT Filed: Sep. 9, 2004
(86) PCT No.: PCT/JP04/13154

§ 371 Date: Nov. 7, 2005

(30) Foreign Application Priority Data
Sep. 22, 2003 (JP) 2003-330163

(51) Int. Cl. G11B 5/65; B05D 5/12

(52) U.S. Cl. 428/836; 427/127; 427/384

(57) ABSTRACT

A method for manufacturing a magnetic recording medium, which enables efficient and ensured manufacture of a magnetic recording medium having a recording layer formed in a concavo-convex pattern and a satisfactorily flat surface, and a magnetic recording medium are provided. According to the method for manufacturing a magnetic recording medium, a material whose state is selectable between a flowing state and a cured state is used as a non-magnetic material 36. After the non-magnetic material 36 is formed in a flowing state on a surface of an object to be processed 10 including a recording layer 32 formed in a concavo-convex pattern over a glass substrate 12, then the non-magnetic material 36 is cured.

### TECHNICAL FIELD

The present invention relates to a method for manufacturing a magnetic recording medium including a recording layer formed in a concavo-convex pattern and a magnetic recording medium.

### BACKGROUND ART

Conventionally, an areal density of a magnetic recording medium such as a hard disk is remarkably increased by improvement such as the miniaturization of magnetic particles forming a recording layer, the modification of a material, or the highly precision processing of head. The areal density is expected to be further increased in the future.

However, problems such as the processing limit of a head, a side fringe due to expansion of a magnetic field, and a crosstalk become noticeable. As a result, the improvement of the areal density by a conventional technique for improvement reaches its limit. Therefore, as a potential magnetic recording medium enabling the realization of further improvement of the areal density, a discrete type magnetic recording medium including a magnetic layer formed in a predetermined concavo-convex pattern has been proposed. In the discrete type magnetic recording medium, a concave portion of the concavo-convex pattern is filled with a non-magnetic material (for example, see Japanese Patent Laid-Open Publication No. Hei 9-97419).

As a processing technique of forming a recording layer in a predetermined concavo-convex pattern, a dry etching technique such as reactive ion etching (for example, see Japanese Patent Laid-Open Publication No. Hei 12-322710) can be employed.

As means of filling a non-magnetic material, a deposition technique such as sputtering, which is employed in the field of semiconductor manufacturing, can be employed. Incidentally, if the deposition technique such as sputtering is employed, a non-magnetic material is deposited not only on concave portions of a concavo-convex pattern but also on the upper surface of a recording layer. As a result, the surface of the non-magnetic material has a concavo-convex shape following that of the recording layer.

In order to obtain a good magnetic characteristic, it is necessary to remove the non-magnetic material on the recording layer as much as possible. Moreover, if the surface of the magnetic recording medium has a level difference, problems such as unstablized flying head and the deposition of a foreign matter may occur. Therefore, it is preferable to flatten the surface of the recording layer while removing an excessive non-magnetic material above the recording layer. A processing technique such as CMP (Chemical Mechanical Polishing) used in the field of semiconductor manufacturing can be employed to remove an excessive non-magnetic material above the recording layer and to flatten the surface of the recording layer.

In the CMP technique, however, the amount of processing is controlled on the basis of time. Therefore, since it is difficult to precisely remove the magnetic material to the surface of the recording layer, the CMP technique is disadvantageous in that the non-magnetic material remains on the recording layer or the recording layer is partially removed. Moreover, if a part of the recording layer is unintentionally polished, a magnetic characteristic is sometimes degraded. Furthermore, the CMP technique is disadvantageous in that the removal of a slurry is difficult and therefore a large amount of time and high cost are required for cleaning and the like. In addition, the CMP technique is also disadvantageous in its low polishing rate.

Moreover, even if the flattening is performed by using the CMP technique or the like, the surfaces of the recording layer and the non-magnetic material cannot be satisfactorily flattened in some cases. The description will be given in greater detail. As shown in FIG. 17(A), the surface of a non-magnetic material 102 is formed in a concavo-convex shape following the concavo-convex shape of a recording layer 104. On the other hand, the concavity and convexity of the surface of the non-magnetic material 102 are gradually flattened while the non-magnetic material 102 is being entirely removed at a flattening step. Therefore, if a thickness of the deposited non-magnetic material is small, a duration of the flattening step effective in flattening the concavity and convexity of the surface is substantially reduced. As a result, as shown in FIG. 17(B), even if the non-magnetic material 102 is removed to the same level as that of the upper surface of the recording layer 104, the concavity and convexity of the surface of the non-magnetic material 102 are not satisfactorily flattened in some cases. Accordingly, it is necessary to deposit the non-magnetic material to have a large thickness so as to flatten the surface.

If the non-magnetic material is deposited to have a large thickness, the duration of the flattening step is substantially prolonged. In this case, however, the efficiency in the use of the material is lowered to disadvantageously increase production cost. Furthermore, along with the prolongation of the duration of the flattening step, the production efficiency is disadvantageously lowered. Furthermore, a thickness of the deposited non-magnetic material tends to vary depending on the area on a substrate at a given rate. If the non-magnetic material is deposited to have a large thickness, a thickness distribution (a difference in thickness) of the non-magnetic material becomes correspondingly large. As a result, the surface flattening effect obtained by depositing the non-magnetic material at a large thickness is reduced or the surface cannot be satisfactorily flattened at the flattening step, sometimes producing the opposite effect of increasing the concavity and convexity of the surface of the magnetic recording medium.

### DISCLOSURE OF INVENTION

In view of the foregoing problems, various exemplary embodiments of this invention provide a method for manufacturing a magnetic recording medium which enables efficient and ensured manufacture of a magnetic recording medium having a recording layer formed in a concavo-convex pattern and a satisfactorily flat surface, and a magnetic recording medium.

In the process of achieving the present invention, the inventors of the present invention tried to remove an excessive non-magnetic material above a recording layer by using ion beam etching so as to flatten the recording layer. Since the ion beam etching is likely to selectively etch away a protruding portion of a film prior to the other part, its flattening effect is high. Furthermore, the use of ion beam etching corresponding to a dry process instead of a wet process such as a CMP technique eliminates the need of cleaning a slurry and the like. Therefore, it is believed that a magnetic recording medium having a small surface roughness can be efficiently manufactured at a low cost.

However, although a certain effect of reducing the surface roughness can be obtained by using ion beam etching, it is still difficult to satisfactorily reduce the surface roughness to a desired level. The reason is generally believed as follows although it is not exactly known.

In the ion beam etching, a projecting portion of a film is likely to be selectively etched away prior to the other part. However, if the projecting portion has a relatively large area, only the vicinity of periphery of the projecting part is etched away fast and the inner area is etched away slower than the periphery thereof. A magnetic recording medium is divided into a data region and a servo region for use. Although a concavo-convex pattern of a recording layer is generally simple in the data region, a concavo-convex pattern of the servo region remarkably differs from that of the data region. Moreover, the concavo-convex pattern of the recording layer often becomes complex in the servo region. Therefore, since a concavo-convex shape of the surface of the non-magnetic material does not have a simple pattern, an etching rate varies depending on the size of area of each projecting portions. Therefore, in spite of the use of ion beam etching, the effect of reducing the surface roughness has a certain limit.

Accordingly, as a result of further diligent examination, the inventors of the present invention achieved the present invention as follows. A material whose state is selectable between a flowing state and a cured state is deposited in a flowing state as a non-magnetic material on a surface of an object to be processed including a recording layer formed in a concavo-convex pattern over a substrate. A concave portion of the concavo-convex pattern is filled with the non-magnetic material to reduce the concavity and convexity of the surface of the non-magnetic material deposited following a concavo-convex shape of the recording layer. Specifically, even if the non-magnetic material has a concavo-convex surface shape following the concavo-convex pattern of the recording layer immediately after deposition, the concavity and convexity are gradually flattened as long as the non-magnetic material is in a flowing state. Therefore, the concavity and convexity of the surface of the non-magnetic material can be remarkably reduced at a stage prior to the flattening step. Furthermore, the concavity and convexity of the surface can be considerably reduced by the flattening that follows. It is preferable to employ dry etching such as ion beam etching for the flattening step.

Specifically, the above-mentioned problems can be solved by various exemplary embodiments of the present invention described below.

(1) A method for manufacturing a magnetic recording medium including a recording layer formed in a predetermined concavo-convex pattern over a substrate, a concave portion of the concavo-convex pattern being filled with a non-magnetic material, the method comprising: the step of forming a layer made of a material having fluidity on a surface of an object to be processed, the surface being formed in the concavo-convex pattern.

(2) The method for manufacturing a magnetic recording medium according to (1), wherein the method comprising: a flowing state non-magnetic material deposition step of depositing a material in a flowing state whose state is selectable between a flowing state and a cured state as the non-magnetic material on the surface of the object to be processed including the recording layer formed in the concavo-convex pattern over the substrate so as to fill the concave portion of the concavo-convex pattern with the non-magnetic material; and a non-magnetic material curing step of curing the non-magnetic material.

(3) The method for manufacturing a magnetic recording medium according to (2), wherein the flowing state non-magnetic material deposition step comprises a cured state non-magnetic material deposition substep of using a material having a melting point of 50° C. or higher and 300° C. or lower as the non-magnetic material so as to deposit the non-magnetic material in a cured state at a temperature lower than the melting point on the surface of the object to be processed, and a non-magnetic material fluidization substep of heating the non-magnetic material at a temperature higher than the melting point and 300° C. or lower so as to fluidize the non-magnetic material; and the non-magnetic material curing step cools the non-magnetic material at a temperature lower than the melting point so as to cure the non-magnetic material.

(4) The method for manufacturing a magnetic recording medium according to (3), wherein a material containing at least one of indium and bismuth is used as the non-magnetic material.

(5) The method for manufacturing a magnetic recording medium according to (3) or (4), wherein the non-magnetic material curing step adds a material containing at least one of silicon, germanium, nitrogen, and boron to a surface of the deposited non-magnetic material in a flowing state so as to elevate the melting point of the non-magnetic material.

(6) The method for manufacturing a magnetic recording medium according to (2), wherein the flowing state non-magnetic material deposition step comprises a cured state non-magnetic material deposition substep of using a thermoplastic resin having a softening temperature of 50° C. or higher and 300° C. or lower as the non-magnetic material to deposit the non-magnetic material in cured state at a temperature lower than the softening temperature on the surface of the object to be processed, and a non-magnetic material fluidization substep of heating the non-magnetic material at a temperature higher than the softening temperature and 300° C. or lower so as to fluidize the non-magnetic material; and the non-magnetic material curing step cools the non-magnetic material at a temperature lower than the softening temperature so as to cure the non-magnetic material.

(7) The method for manufacturing a magnetic recording medium according to (2), wherein the flowing state non-magnetic material deposition step uses a thermosetting resin having a curing temperature of 50° C. or higher and 300° C. or lower as the non-magnetic material to deposit the non-magnetic material in flowing state at a temperature lower than the curing temperature on the surface of the object to be processed; and the non-magnetic material curing step heats the non-magnetic material at a temperature higher than the curing temperature and 300° C. or lower so as to cure the non-magnetic material.

(8) The method for manufacturing a magnetic recording medium according to (2), wherein the flowing state non-magnetic material deposition step uses a radiation curable resin as the non-magnetic material to deposit the non-magnetic material in a flowing state on the surface of the object to be processed; and the non-magnetic material curing step radiates radiation so as to cure the non-magnetic material.

(9) The method for manufacturing a magnetic recording medium according to any one of (2) to (8), wherein the flowing state non-magnetic material deposition step rotates the object to be processed around an axis approximately perpendicular to the surface of the object to be processed while the object to be processed on which the non-magnetic material in the flowing state is deposited is approximately horizontally held.

(10) The method for manufacturing a magnetic recording medium according to any one of (2) to (8), wherein a flattening step of removing an excessive non-magnetic material so as to flatten the surface of the object to be processed is provided after the non-magnetic material curing step.

(11) The method for manufacturing a magnetic recording medium according to (1), wherein the method comprising: a non-magnetic material deposition step of depositing the non-magnetic material on the surface of the object to be processed including the recording layer formed in the concavo-convex pattern over the substrate so as to fill the concave portion of the concavo-convex pattern with the non-magnetic material; a fluid material deposition step of depositing a fluid material on a surface of the non-magnetic material; and a flattening step of removing the fluid material and an excessive non-magnetic material so as to flatten the surface of the object to be processed.

(12) The method for manufacturing a magnetic recording medium according to (10) or (11), wherein the flattening step employs a dry etching technique.

(13) A magnetic recording medium comprising a recording layer formed in a predetermined concavo-convex pattern over a substrate, a concave portion of the concavo-convex pattern being filled with a non-magnetic material, wherein the non-magnetic material contains at least one of indium and bismuth.

In this application, the phrase “a recording layer formed in a predetermined concavo-convex pattern over a substrate” means to encompass: a case where a recording layer is formed in a predetermined pattern over a substrate so as to be divided into a large number of recording elements, and the recording elements serve as convex portions and concave portions are formed between the recording elements; a case where a recording layer is formed in a predetermined pattern over a substrate so as to be partially divided, and partially continuous recording elements serve as a convex portion and concave portions are formed between the recording elements, for example, a case where a recording layer is formed in a spiral shape and continuous recording element is formed over a part of the substrate so that the recording element serves as convex portions and concave portion is formed in space of the recording element; and a case where a convex portion and a concave portion are both formed on the recording layer.

The term “radiation” generally means an electromagnetic wave such as a γ-ray, an X-ray, and a particle beam such as an α-ray, which is released along with the decay of a radioactive element. In this application, however, the term “radiation” collectively denotes electromagnetic waves and particle beams, for example, an ultraviolet ray and an electron beam, which have a property of curing a specific resin in a flowing state.

Moreover, the term “magnetic recording medium” used in this application means not only a hard disk, a floppy (registered trademark) disk, a magnetic tape and the like, which uses only magnetism for recording and reading information, but also a magneto optical recording medium such as an MO (Magneto Optical) using both magnetism and light and a thermally assisted type recording medium using both magnetism and heat.

In the present invention, a non-magnetic material is deposited in a flowing state, so that the concavity and convexity of the surface of the non-magnetic material can be satisfactorily flattened prior to flattening. Therefore, a surface roughness can be satisfactorily reduced to a desired level at the flattening step. As a result, a magnetic recording medium having a recording layer formed in a concavo-convex pattern and a satisfactorily flat surface can be efficiently and surely manufactured.

### BRIEF DESCRIPTION OF DRAWINGS

FIG. 1 is a schematic sectional side view showing the structure of a starting body of an object to be processed according to a first exemplary embodiment of the present invention;

FIG. 2 is a schematic sectional side view showing the structure of a magnetic recording medium obtained by processing the object to be processed;

FIG. 3 is a flowchart showing the outline of a process of manufacturing the magnetic recording medium;

FIG. 4 is a schematic sectional side view showing the shape of the object to be processed including a resist layer having a concavo-convex pattern obtained by transfer;

FIG. 5 is a schematic sectional side view showing the shape of the object to be processed from which a resist layer under a bottom face of a concave portion is removed;

FIG. 6 is a schematic sectional side view showing the shape of the object to be processed from which a second mask layer under the bottom face of the concave portion is removed;

FIG. 7 is a schematic sectional side view showing the shape of the object to be processed from which a first mask layer under the bottom face of the concave portion is removed;

FIG. 8 is a schematic sectional side view showing the shape of the object to be processed on which recording elements are formed;

FIG. 9 is a schematic sectional side view showing the shape of the object to be processed from which the first layer remaining on upper faces of the recording elements is removed;

FIG. 10 is a schematic sectional side view showing the shape of the object to be processed in the state where separation films are formed on the upper face of the recording element and the concave portion between the recording elements;

FIG. 11 is a schematic sectional side view showing the shape of a non-magnetic material immediately after deposition on a surface of the object to be processed;

FIG. 12 is a schematic sectional side view showing the shape in the state where the non-magnetic material is heated to be in a flowing state to flatten concavity and convexity thereof;

FIG. 13 is a schematic sectional side view showing the shape of the object to be processed in the state where surfaces of the recording elements and the non-magnetic material are flattened;

FIG. 14 is a flowchart showing the outline of a process of manufacturing a magnetic recording medium according to a second exemplary embodiment of the present invention;

FIG. 15 is a sectional side view showing the state where a fluid material is further deposited on a non-magnetic material deposited on a surface of an object to be processed according to the second exemplary embodiment;

FIG. 16 is a schematic sectional side view showing the shape of the object to be processed in the state where surfaces of recording elements and the non-magnetic material are flattened; and

FIG. 17 is a schematic sectional side view showing the shape of a deposited conventional non-magnetic material and the sectional shape of surfaces of conventional recording elements and the non-magnetic material after flattening.

### BEST MODE FOR CARRYING OUT THE INVENTION

Hereinafter, preferred exemplary embodiments of the present invention will be described in detail with reference to the accompanying drawings.

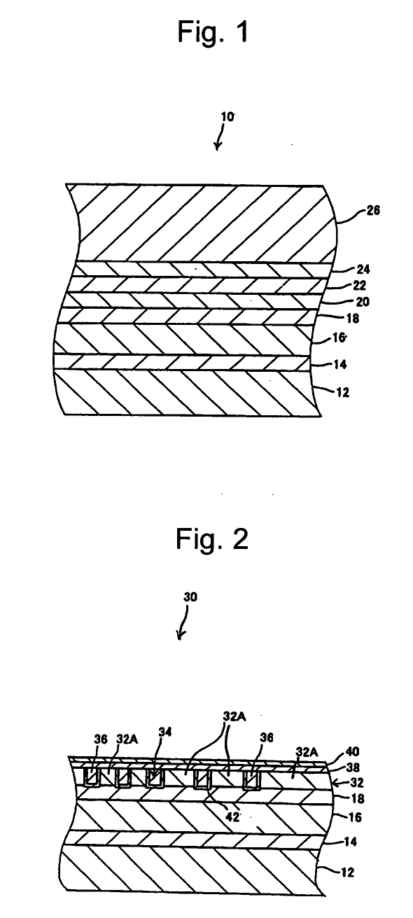

A first exemplary embodiment of the present invention relates to a method for manufacturing a magnetic recording medium as shown in FIG. 2. According to this method, a starting body of an object to be processed as shown in FIG. 1, which includes a continuous recording layer and the like formed over a substrate, is processed so that the continuous recording layer is divided into a large number of recording elements in a predetermined concavo-convex pattern. At the same time, concave portions (corresponding to concave portions of the concavo-convex pattern) between the recording elements are filled with a non-magnetic material. This manufacturing method is characterized by its non-magnetic material filling step. Since the other steps are similar to those of a conventional method, the description thereof is appropriately omitted.

As shown in FIG. 1, a starting body of an object to be processed 10 includes: an underlayer 14; a soft magnetic layer 16; a seed layer 18; a continuous recording layer 20; a first mask layer 22; a second mask layer 24; and a resist layer 26 formed in this order over a glass substrate 12.

The underlayer 14 has a thickness of 30 to 200 nm and is made of Ta (tantalum), Cr (chromium) or a Cr alloy.

The soft magnetic layer 16 has a thickness of 50 to 300 nm and is made of an Fe (iron) alloy or a Co (cobalt) alloy.

The seed layer 18 has a thickness of 3 to 30 nm and is made of Cr, a non-magnetic CoCr alloy, Ti (titanium), MgO (magnesium oxide) or the like.

The continuous recording layer 20 has a thickness of 5 to 30 nm and is made of a CoCr (cobalt-chromium) alloy.

The first mask layer 22 has a thickness of 3 to 50 nm and is made of TiN (titanium nitride).

The second mask layer 24 has a thickness of 3 to 30 nm and is made of Ni (nickel).

The resist layer 26 has a thickness of 30 to 300 nm and is made of a negative type resist (NBE22A manufactured by Sumitomo Chemical Co., Ltd.).

As shown in FIG. 2, a magnetic recording medium 30 is a perpendicular recording discrete type magnetic disk. A recording layer 32 has a concavo-convex pattern obtained by dividing the continuous recording layer 20 into a large number of recording elements 32A at fine intervals. Specifically, the recording elements 32A are concentrically formed at fine intervals in a radial direction of tracks in a data region while being formed in a pattern of predetermined servo information and the like in a servo region. Concave portions 34 between the recording elements 32A are filled with a non-magnetic material 36. A protective layer 38 and a lubricating layer 40 are formed in this order over the recording elements 32A and the non-magnetic material 36. A separation film 42 is formed between the recording element 32A and the non-magnetic material 36.

The non-magnetic material 36 is specifically In (indium) and has a melting point of approximately 156.6° C.

The protective layer 38 has a thickness of 1 to 5 nm and is formed of a hard carbon film called diamond like carbon. The term “diamond like carbon” (hereinafter referred to as “DLC”) in this application is used to designate a material on the basis of carbon, which has an amorphous structure and exhibits a hardness of about 200 to 8000 kgf/mm² in Vickers hardness measurement.

The lubricating layer 40 has a thickness of 1 to 2 nm and is made of PFPE (perfluoropolyether).

The separation film 42 has a thickness of 1 to 20 nm and is made of diamond like carbon like the material of the protective layer 38.

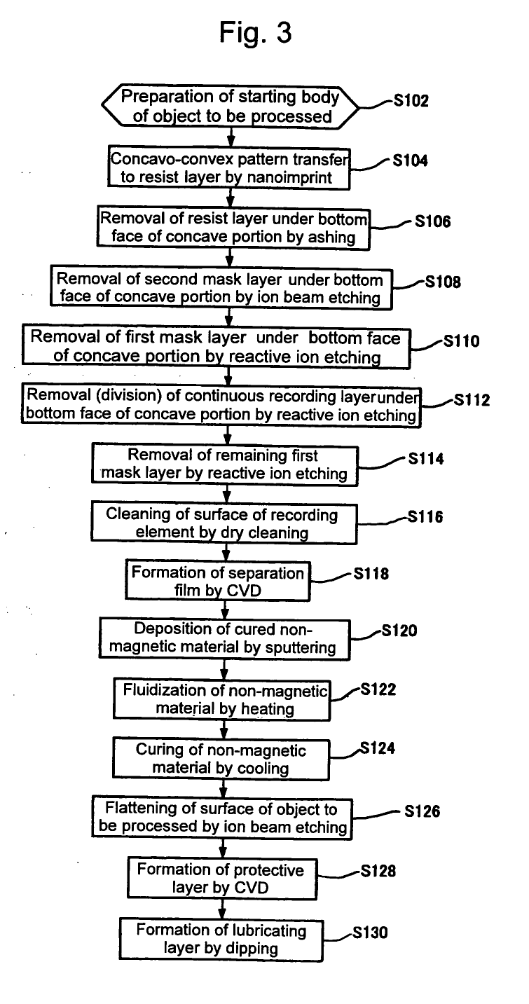

Next, a method of processing the object to be processed 10 will be described in accordance with a flowchart of FIG. 3.

First, a starting body of the object to be processed 10 shown in FIG. 1 is prepared (S102). The starting body of the object to be processed 10 is obtained by forming the underlayer 14, the soft magnetic layer 16, the seed layer 18, the continuous recording layer 20, the first mask layer 22, and the second mask layer 24 in this order over the glass substrate 12 by sputtering and then applying the resist layer 26 thereon by dipping. Alternatively, the resist layer 26 may be applied by spin coating.

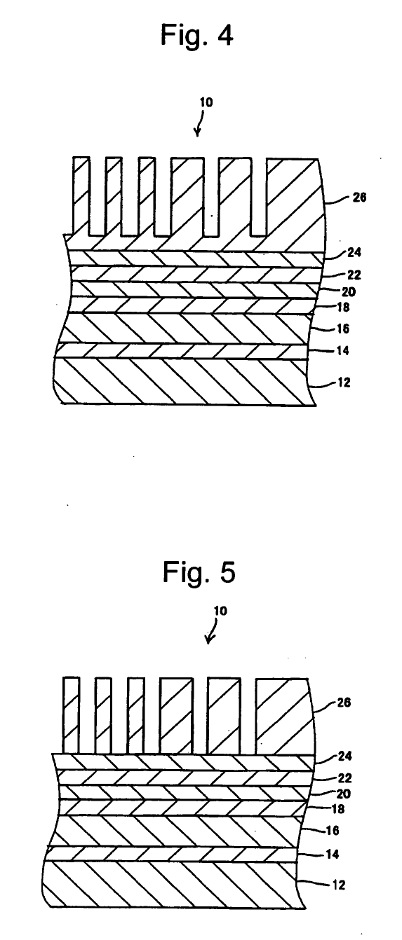

A predetermined servo pattern including a contact hole is transferred by using a transfer device (not shown) by nanoimprinting to the resist layer 26 in a servo region of the starting body of the object to be processed 10, whereas a concavo-convex pattern as shown in FIG. 4 is transferred at radial fine intervals to the resist layer 26 in a data region (S104). Alternatively, the resist layer 26 may be exposed to light and developed so as to form the concavo-convex pattern.

Subsequently, the resist layer 26 under a bottom face of a concave portion of the concavo-convex pattern is removed by ashing as shown in FIG. 5 (S106). Although the resist layer 26 in an area other than the concave portions is slightly removed at this step, the resist layer 26 remains for a level difference from the bottom face of the concave portion.

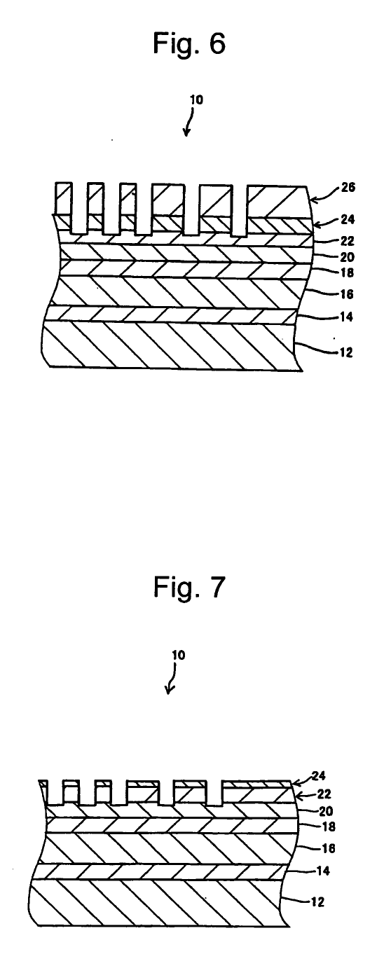

Next, the second mask layer 24 under the bottom face of the concave portion is etched away by ion beam etching using Ar (argon) gas as shown in FIG. 6 (S108). At this step, the resist layer 26 in an area other than the concave portions is slightly etched away.

Next, the first mask layer 22 under the bottom face of the concave portion is etched away by reactive ion etching using SF₆ (sulfur hexafluoride) gas as shown in FIG. 7 (S110) As a result, the continuous recording layer 20 is exposed on the bottom face of the concave portion. At this step, the resist layer 26 in the area other than the concave portions is perfectly removed. Although the second mask layer 24 in the area other than the concave portions is also partially removed, a certain amount of the second mask layer 24 remains.

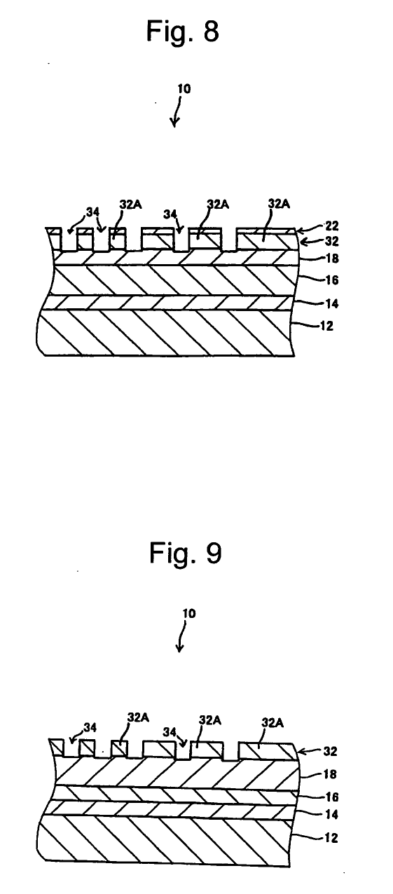

Next, the continuous recording layer 20 under the bottom face of the concave portion is etched away by reactive etching using CO gas and NH₃ gas as reactive gas as shown in FIG. 8 (S112). As a result, the continuous recording layer 20 is divided into a large number of recording elements 32A.

By the reactive ion etching, the second mask layer 24 in the area other than the concave portions is completely removed. Although the first mask layer 22 in the area other than the concave portions is also partially removed, a certain amount of the first mask layer 22 remains on upper surfaces of the recording elements 32A.

Next, the first mask layer 22 remaining on the upper surfaces of the recording elements 32A is completely removed by reactive ion etching using SF₆ gas as reactive gas as shown in FIG. 9 (S114).

Subsequently, the surface of the object to be processed is cleaned (S116). Specifically, reducing gas such as NH₃ gas is supplied to remove the SF₆ gas and the like on the surface of the object to be processed 10.

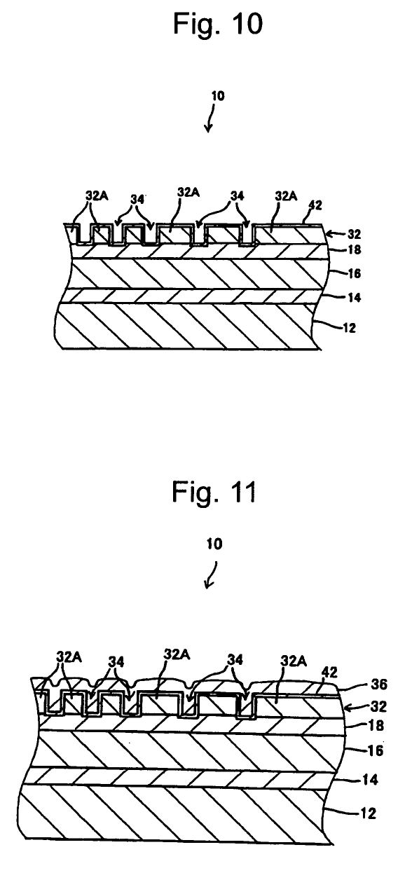

Next, the separation films 42 made of DLC are deposited on the recording elements 32A by a CVD technique as shown in FIG. 10 (S118).

Then, In (the non-magnetic material 36) particles are deposited in a cured state by sputtering at a lower temperature than the melting point thereof on the surface of the object to be processed 10 to fill the concave portions 34 between the recording elements 32A as shown in FIG. 11 (S120). Herein, the non-magnetic material 36 is deposited so as to completely cover the separation film 42. The non-magnetic material 36 is formed to have a concavo-convex shaped surface following the concavo-convex pattern of the recording layer 32. Since the recording elements 32A are covered with and protected by the separation film 42, the recording elements 32A are never degraded by sputtering of the non-magnetic material 36.

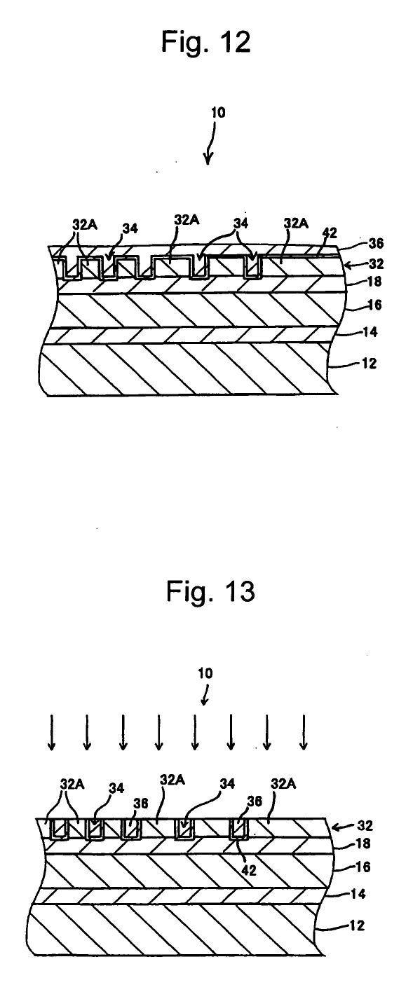

Next, the object to be processed 10 is heated to a temperature higher than the melting point of In, 156.6° C., and equal to or lower than 300° C. so as to fluidize the non-magnetic material 36 (S122). As a result, the non-magnetic material 36 flows due to gravity to flatten the concavity and convexity of the surface thereof as shown in FIG. 12. Since the heating temperature is 300° C. or lower, the recording layer 32 can be prevented from being degraded by heating the object to be processed 10. In order to further ensure the prevention of degradation of the recording layer 32, it is preferred to set the heating temperature to 200° C. or lower. At this step, the object to be processed 10, on which the non-magnetic material 36 in a flowing state is deposited, is approximately horizontally held so as to be rotated around an axis approximately perpendicular to the surface of the object to be processed 10. As a result, the flow of the non-magnetic material 36 is accelerated so as to reduce time for flattening the concavity and convexity of the surface thereof.

When the concavity and convexity of the surface of the non-magnetic material 36 are satisfactorily flattened, Si (silicon) particles are added to the surface of the non-magnetic material 36. As a result, the melting point of the non-magnetic material 36 is elevated. Then, the object to be processed 10 is cooled at a temperature lower than the melting point of In, 156.6° C., so as to cure the non-magnetic material 36 (S124). Since the Si (silicon) particles are added to the surface of the non-magnetic material 36, the curing is accelerated. Accordingly, the non-magnetic material 36 is cured while keeping a flat surface.

Subsequently, the excessive non-magnetic material 36 above the upper faces of the recording elements 32A on the side opposite to the substrate 12 (on the upper side in FIG. 12) is etched away by ion beam etching using Ar (argon) gas so as to flatten the surface of the object to be processed 10 as shown in FIG. 13 (S126). The separation films 42 on the upper faces of the recording elements 32A may be completely removed or partially left.

Since the non-magnetic material 36 is deposited while the concavity and convexity on its surface are flattened, the non-magnetic material 36 is entirely uniformly removed by ion beam etching so as to further flatten the concavity and convexity of the surface to flatten the non-magnetic material 36. If the surface of the non-magnetic material 36 is satisfactorily flattened at the non-magnetic material fluidizing step (S122), an incident angle of an Ar ion is satisfactorily set within the range of 30 to 90°. With the setting as described above, a processing rate is increased to enhance production efficiency. On the other hand, if the surface of the non-magnetic material 36 is to be further flattened, the incident angle of the Ar ion is satisfactorily set within the range of −10 to 15° with respect to the surface. In this application, the term “ion beam etching” is used to collectively designate a processing method of radiating an ionized gas to the object to be processed for etching away, for example, ion milling or the like, and is not limited to a processing method of narrowing and radiating an ion beam. The term “incident angle” is used to designate an incident angle with respect to the surface of the object to be processed, which corresponds to an angle formed between the surface of the object to be processed and the center axis of an ion beam. For example, if the center axis of the ion beam is parallel to the surface of the object to be processed, the incident angle is 0°. If the center axis of the ion beam is perpendicular to the surface of the object to be processed, the incident angle is +90°.

Next, the protective layer 38 is formed on the upper surfaces of the recording elements 32A and the non-magnetic material 36 by a CVD (Chemical Vapor Deposition) technique (S128).

Furthermore, the lubricating layer 40 is applied onto the protective layer 38 by dipping (S130). As a result, the magnetic recording medium 30 as shown in FIG. 2 above is completed.

As described above, the non-magnetic material 36 is deposited while the concavity and convexity of the surface thereof are being flattened. Then, the surfaces of the recording elements 32A and the non-magnetic material 36 are further flattened at the flattening step (S126). As a result, the lubricating layer 40 is also formed to have a flat surface.

In this exemplary embodiment, the non-magnetic material 36 is deposited by sputtering. However, the present invention is not limited thereto. The non-magnetic material 36 may be deposited by the other deposition techniques, for example, ion beam deposition or the like.

For curing the non-magnetic material 36, the Si (silicon) particles are added to the surface of the non-magnetic material 36 in a flowing state so as to accelerate the curing in this exemplary embodiment. However, the present invention is not limited thereto. The melting point of the non-magnetic material 36 may be elevated by adding B (boron), N (nitrogen), Ge (germanium), or the like so as to accelerate the curing. Moreover, the same effect can be obtained if a mixed material of Si, B and N or a material containing at least one of these materials is added to the surface of the non-magnetic material 36 in a flowing state.

Although the non-magnetic material 36 is In in this exemplary embodiment, the present invention is not limited thereto. The other non-magnetic materials, for example, Bi (bismuth) or the like may be used as long as they have a melting point of 50° C. or higher and 300° C. or lower, which are suitable for a deposition technique such as sputtering or ion beam deposition. The melting point of Bi is approximately 271° C.

Alternatively, a thermoplastic resin having a softening point of 50° C. or higher and 300° C. or lower may be used as the non-magnetic material 36. After the thermoplastic resin in a cured state at a lower temperature than the softening temperature is deposited on the surface of the object to be processed 10, the thermoplastic resin is heated to a temperature higher than the softening temperature and equal to 300° C. or lower so as to be fluidized. Then, the thermoplastic resin is cooled at a temperature lower than the softening temperature so as to cure the thermoplastic resin.

Further alternatively, a thermosetting resin having a curing temperature of 50° C. or higher and 300° C. or lower may be used as the non-magnetic material 36. After the thermosetting resin in a flowing state at a temperature lower than the curing temperature is deposited on the surface of the object to be processed 10, the thermosetting resin is heated to a temperature higher than the curing temperature and 300° C. or lower so as to be cured.

Further alternatively, a radiation curable resin such as an ultraviolet curable resin and an electron beam curable resin may be used as the non-magnetic material 36. After the radiation curable resin in a flowing state is deposited on the surface of the object to be processed 10, radiation such as an ultraviolet ray or an electron beam may be radiated so as to cure the radiation curable resin.

In this exemplary embodiment, the object to be processed 10 is rotated around the axis approximately perpendicular to the surface while the object to be processed 10, on which the non-magnetic material 36 is deposited in a flowing state, is approximately horizontally kept. In this manner, the flow of the non-magnetic material 36 is accelerated to reduce the time for flattening the concavity and concavity of the surface thereof. However, the present invention is not limited thereto. If the concavity and convexity of the surface of the non-magnetic material 36 can be easily flattened only by gravity, the non-magnetic material 36 may be deposited while the object to be processed 10 remains stationary.

Next, a second exemplary embodiment of the present invention will now be described.

In contrast with the first exemplary embodiment described above, a non-magnetic material 37 made of SiO₂ (silicon dioxide) is used in place of the non-magnetic material 36 made of In and a technique of flattening a surface of the non-magnetic material 37 is modified in this exemplary embodiment. Since the other points are similar to those in the first exemplary embodiment above, they are denoted by the same reference numerals as those in FIGS. 1 to 13 so as to omit the description thereof.

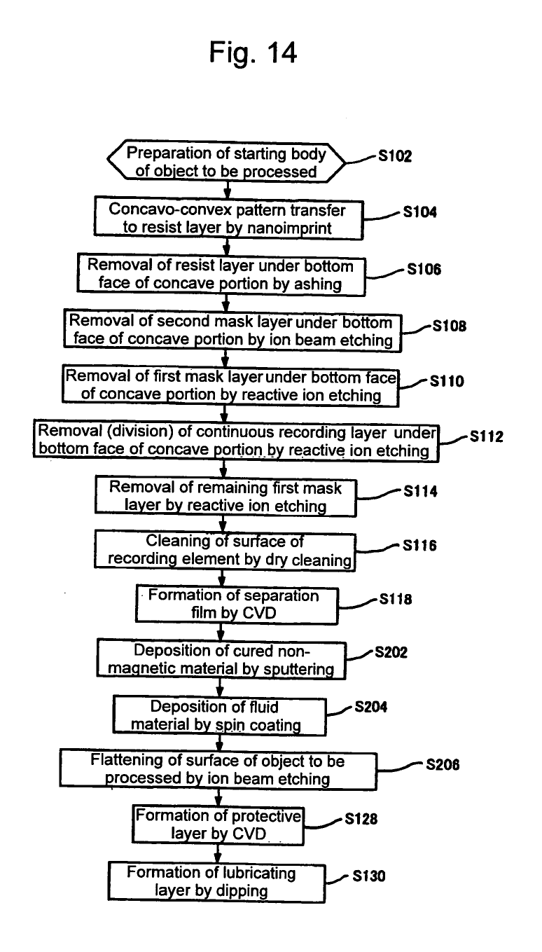

As shown in a flowchart of FIG. 14, SiO₂ (silicon dioxide) is deposited by sputtering as the non-magnetic material 37 on the surface of the object to be processed 10 including the recording layer 32 formed in a concavo-convex pattern over the substrate 12. In this manner, the concave portions 34 between the recording elements 32A are filled with the non-magnetic material 37 (S202). Like the shape shown in FIG. 11 above, the non-magnetic material 37 is deposited in a cured state to have a concavo-convex shaped surface following the concavo-convex pattern of the recording elements 32A.

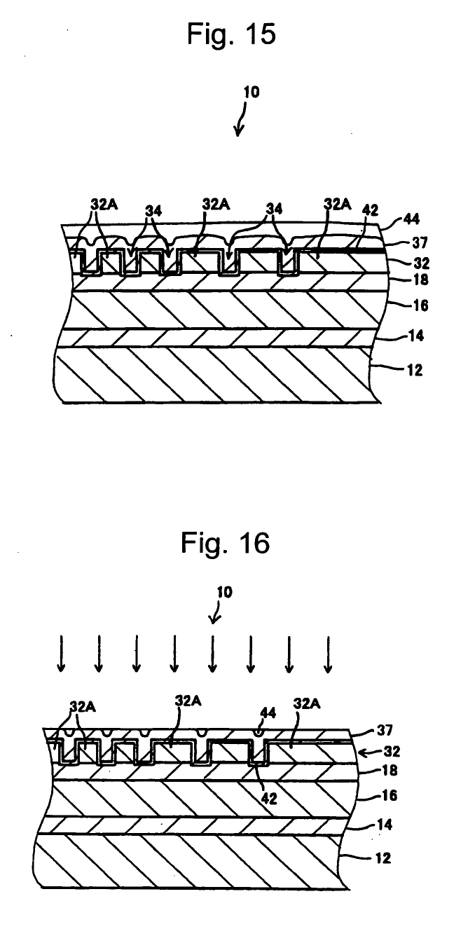

Next, a fluid material 44 is further deposited on a surface of the non-magnetic material 37 (S204). The fluid material 44 is specifically a resist material. The concavity and convexity are flattened by gravity owing to fluidity of the fluid material 44 as shown in FIG. 15. As a result, the fluid material 44 is deposited so as to have a nearly flat surface. At this step, the object to be processed 10, on which the fluid material 44 is deposited, is rotated around the axis approximately perpendicular to the surface. As a result, the flow of the fluid material 44 is accelerated so as to reduce the time for flattening the concavity and convexity of the surface thereof.

Next, the fluid material 44 and the excessive non-magnetic material 37 are etched away by ion beam etching using Ar gas so as to flatten the surface of the object to be processed 10 (S206). An incident angle of Ar ion or the like is the same as that at the flattening step (S126) in the first exemplary embodiment described above.

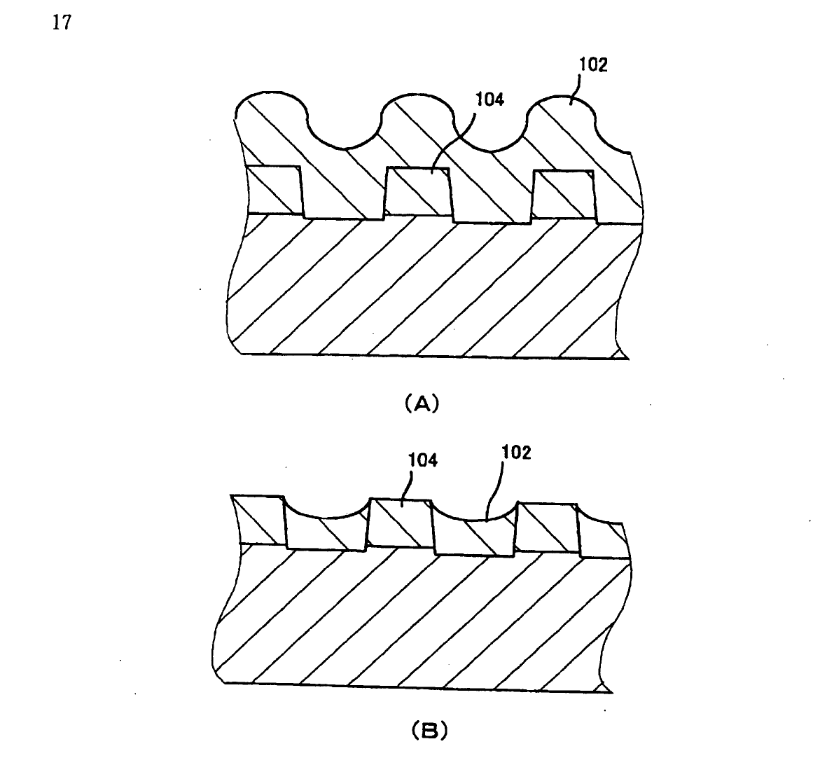

Since the fluid material 44 is deposited so that the concavo-convex shape of the surface thereof is kept extremely small, the concavity and convexity of the surface of the non-magnetic material 37 are surely flattened while the non-magnetic material 37 is being entirely uniformly removed by ion beam etching as shown in FIG. 16. As a result, the non-magnetic material 37 is flattened to have similar shape to that shown in FIG. 13 above.

The non-magnetic material 37 is in a cured state, whereas the fluid material 44 is in a flowing state. Since a difference in etching rate due to a difference of the material to be processed is small in ion beam etching, the surfaces of the recording elements 32A and the non-magnetic material 37 can be flattened while the fine concavity and convexity of the surface of the fluid material 44 are being further flattened.

Hereinafter, the protective layer 38 and the lubricating layer 40 are formed in the same manner as that in the first exemplary embodiment above to complete the magnetic recording medium 30.

Although the non-magnetic material 37 is SiO₂ in this second exemplary embodiment, the present invention is not limited thereto. The other non-magnetic materials may be used as long as they are suitable for a deposition technique such as sputtering or ion beam deposition.

Although the fluid material 44 is a resist material in this second exemplary embodiment, the present invention is not limited thereto. The other fluid materials can be used as long as the surface is flattened by gravity or the like.

It is preferred to use a material having a small difference in etching rate with respect to ion beam etching as the non-magnetic material 37 and the fluid material 44.

Although the fluid material 44 and the excessive non-magnetic material 37 are removed without curing the fluid material 44 so as to flatten the surface of the object to be processed 10 in this second exemplary embodiment, the present invention is not limited thereto. Before the surface of the object to be processed 10 is flattened, the fluid material 44 may be cured after the surface of the fluid material 44 is flattened by gravity or the like.

The object to be processed 10, on which the fluid material 44 is deposited, is rotated around the axis approximately perpendicular to its surface so as to accelerate the flow of the fluid material 44 to reduce the time for flattening the concavity and convexity of the surface thereof also in this second exemplary embodiment. However, the present invention is not limited thereto. If the fluid material 44 can be satisfactorily flattened by gravity, the fluid material 44 may be deposited while the object to be processed 10 remains stationary.

The non-magnetic material 36 or 37 is removed to the upper surfaces of the recording elements 32A by ion beam etching using the argon gas so as to flatten the surface of the object to be processed 10 in the first and second exemplary embodiments described above. However, the present invention is not limited thereto. For example, the non-magnetic material 36 or 37 may be removed to the upper faces of the recording elements 32A by ion beam etching using another rare gas, for example, Kr (krypton) or Xe (xenon) so as to flatten the surface of the object to be processed 10. Alternatively, the surface of the object to be processed 10 may be flattened by reactive ion beam etching using halogen containing gas such as SF₆, CF₄ (carbon tetrafluoride) or C₂F₆ (ethane hexafluoride). Moreover, also in the case where the surface of the object to be processed 10 is flattened by using a CMP (Chemical Mechanical Polishing) technique, the higher effect of reducing the concavity and convexity of the surface than that obtained in the conventional method can be obtained by flattening the concavity and convexity of the surfaces of the non-magnetic material 36 or 37 and the fluid material 44 prior to the flattening.

Although the concavity and convexity of the surface of the non-magnetic material 36 or 37 are reduced by using a material having fluidity in the first and second exemplary embodiments described above, the present invention is not limited thereto. For example, the concavity and convexity of the surface of the other layers such as the protective layer 38 may be reduced by using a material having fluidity. In this case, a state of a material of the other layers such as the protective layer 38 may be selectable between a flowing state and a cured state as in the case of the first exemplary embodiment. Alternatively, as in the second exemplary embodiment, after the deposition of the fluid material on the other layer such as the protective layer 38, the fluid material and a part of the other layer such as the protective layer 38 may be removed so as to flatten the surface of the other layer.

In the first and second exemplary embodiments described above, after the first mask layer 22, the second mask layer 24 and the resist layer 26 are formed over the continuous recording layer 20, the continuous recording layer 20 is divided by three-step dry etching. However, the material of the resist layer or the mask layer, the number of deposited layers, the thickness thereof, the type of dry etching or the like is not particularly limited as long as the continuous recording layer 20 can be divided at high precision.

Although the material of the recording layer 32 (the continuous recording layer 20) is a CoCr alloy in the first and second exemplary embodiments described above, the present invention is not limited thereto. For example, the present invention is applicable to process a magnetic recording medium including recording elements made of the other materials, for example, the other alloys containing an iron element (Co, Fe (iron) or Ni), a laminate thereof or the like.

Although the underlayer 14, the soft magnetic layer 16, and the seed layer 18 are formed below the continuous recording layer 20 in the first and second exemplary embodiments described above, the present invention is not limited thereto. A structure of the layers below the continuous recording layer 20 may be appropriately changed in accordance with the kind of a magnetic recording medium. For example, one or two of the underlayer 14, the soft magnetic layer 16, and the seed layer 18 may be omitted. Moreover, each of the layers may be composed of a plurality of sublayers. Furthermore, the continuous recording layer may be directly formed on the substrate.

Although the magnetic recording medium 30 is a perpendicular recording discrete type magnetic disk including the recording elements 32A provided side by side in the data region at fine intervals in a radial direction of tracks, the present invention is not limited thereto. It is apparent that the present invention is applicable to the manufacture of the following magnetic disks: a magnetic disk including recording elements provided side by side at fine intervals in a circumferential direction of tracks (a sector direction); a magnetic disk including recording elements provided side by side at fine intervals in a radial direction of tracks as well as in a circumferential direction of tracks; a PERM type magnetic disk including a continuous recording layer formed in a concavo-convex pattern; and a magnetic disk including spiral tracks. Moreover, the present invention is also applicable to the manufacture of a magneto optical disc such as an MO, a thermally assisted type magnetic disk using both magnetism and heat, and, in addition, the other discrete type magnetic recording media having a shape other than a disc shape, such as a magnetic tape.

### EXAMPLE 1

As described in the first exemplary embodiment above, ten magnetic recording media 30 were manufactured by using In as the non-magnetic material 36. Specifically, after In was deposited by sputtering on the surface of the object to be processed 10 including the recording layer 32 formed in a concavo-convex pattern over the substrate 12, the object to be processed 10 was kept and heated in a temperature environment at approximately 200° C. for approximately 5 minutes while being rotated so as to flatten the surface of In. Next, the object to be processed 10 was kept and cooled in a normal temperature environment with the addition of an extremely small amount of Si particles to the surface of In, thereby curing In. Then, Ar gas was radiated approximately perpendicularly to the surface of the object to be processed 10 so as to remove In until the surfaces of the recording elements 32A were exposed. In this manner, the surface of the object to be processed 10 was flattened. Furthermore, the protective layer 38 and the lubricating layer 40 were formed to manufacture ten magnetic recording media 30. As a result of measurement of the largest level difference of the surface of each magnetic recording medium 30, the largest level difference was 1 nm or less for each of the magnetic recording media 30.

### EXAMPLE 2

In contrast with Example 1, ten magnetic recording media 30 were manufactured by using an ultraviolet curable resin as the non-magnetic material 36 in place of In. Specifically, after the ultraviolet curable resin was deposited by spin coating on the surface of the object to be processed 10 including the recording layer 32 formed in a concavo-convex pattern over the substrate 12, an ultraviolet ray was radiated onto the ultraviolet curable resin for approximately 5 minutes so as to cure it. Then, Ar gas was radiated approximately perpendicularly to the surface of the object to be processed 10 so as to remove the ultraviolet curable resin until the surfaces of the recording elements 32A were exposed. In this manner, the surface of the object to be processed 10 was flattened. The other conditions were set the same as those of Example 1 above. As a result of measurement of the largest level difference of the surface of each magnetic recording medium 30 obtained in the above-described manner, the largest level difference was 1 nm or less for each of the magnetic recording media 30.

### EXAMPLE 3

As described in the second exemplary embodiment above, ten magnetic recording media 30 were manufactured by using SiO₂ as the non-magnetic material 37. Specifically, after SiO₂ was deposited by sputtering on the surface of the object to be processed 10 including the recording layer 32 formed in a concavo-convex pattern over the substrate 12, the resist material was deposited by spin coating on the surface of SiO₂ while the object to be processed 10 was being rotated. Next, Ar gas was radiated approximately perpendicularly to the surface of the object to be processed 10 so as to remove the resist material and SiO₂ until the surfaces of the recording elements 32A were exposed. In this manner, the surface of the object to be processed 10 was flattened. The Ar gas was radiated without curing the resist material in a flowing state. Furthermore, the protective layer 38 and the lubricating layer 40 were formed to manufacture ten magnetic recording media 30. As a result of measurement of the largest level difference of the surface of each magnetic recording medium 30, the largest level difference was 1 nm or less for each of the magnetic recording media 30.

### COMPARATIVE EXAMPLE

As in Example 3 described above, ten magnetic recording media 30 were manufactured by using SiO₂ as the non-magnetic material 37. In this Comparative Example, SiO₂ was deposited by sputtering on the surface of the object to be processed 10 including the recording layer 32 formed in a concavo-convex pattern over the substrate 12, whereas the resist material was not deposited on the surface of SiO₂. In order to enhance the effect of flattening the concavity and convexity of the surface of deposited SiO₂, Ar gas was radiated at an inclined incident angle to the surface of the object to be processed 10 so as to remove SiO₂ until the surfaces of the recording elements 32A were exposed. In this manner, the surface of the object to be processed 10 was flattened. Furthermore, the protective layer 38 and the lubricating layer 40 were formed to manufacture ten magnetic recording media 30. As a result of measurement of the largest level difference of the surface of each magnetic recording medium 30, an average value of the largest level differences of the surfaces of the ten magnetic recording media 30 was 18 nm.

As described above, it is confirmed that the level difference of the surface of the magnetic recording medium can be remarkably reduced according to Examples 1 to 3 in comparison with Comparative Example.

In the case of a hard disk, a head flying height is generally 12 nm. The result of simulation that the level difference of the surface set to 5 nm or less is preferred to keep good head flying has been reported. Therefore, according to Examples 1 to 3 described above, it is understood that good head flying can be surely obtained.

### INDUSTRIAL APPLICABILITY

The present invention can be employed for manufacturing a magnetic recording medium including a recording layer formed in a concavo-convex pattern, for example, a discrete type hard disk or the like.

1. A method for manufacturing a magnetic recording medium including a recording layer formed in a predetermined concavo-convex pattern over a substrate, a concave portion of the concavo-convex pattern being filled with a non-magnetic material, the method comprising:
the step of forming a layer made of a material having fluidity on a surface of an object to be processed, the surface being formed in the concavo-convex pattern.

2. The method for manufacturing a magnetic recording medium according to claim 1, wherein the method comprising: a flowing state non-magnetic material deposition step of depositing a material in a flowing state whose state is selectable between a flowing state and a cured state as the non-magnetic material on the surface of the object to be processed including the recording layer formed in the concavo-convex pattern over the substrate so as to fill the concave portion of the concavo-convex pattern with the non-magnetic material; and a non-magnetic material curing step of curing the non-magnetic material.

3. The method for manufacturing a magnetic recording medium according to claim 2, wherein
the flowing state non-magnetic material deposition step comprises a cured state non-magnetic material deposition substep of using a material having a melting point of 50° C. or higher and 300° C. or lower as the non-magnetic material so as to deposit the non-magnetic material in a cured state at a temperature lower than the melting point on the surface of the object to be processed, and a non-magnetic material fluidization substep of heating the non-magnetic material at a temperature higher than the melting point and 300° C. or lower so as to fluidize the non-magnetic material; and
the non-magnetic material curing step cools the non-magnetic material at a temperature lower than the melting point so as to cure the non-magnetic material.

4. The method for manufacturing a magnetic recording medium according to claim 3, wherein
a material containing at least one of indium and bismuth is used as the non-magnetic material.

5. The method for manufacturing a magnetic recording medium according to claim 3, wherein
the non-magnetic material curing step adds a material containing at least one of silicon, germanium, nitrogen, and boron to a surface of the deposited non-magnetic material in a flowing state so as to elevate the melting point of the non-magnetic material.

6. The method for manufacturing a magnetic recording medium according to claim 4, wherein
the non-magnetic material curing step adds a material containing at least one of silicon, germanium, nitrogen, and boron to a surface of the deposited non-magnetic material in a flowing state so as to elevate the melting point of the non-magnetic material.

7. The method for manufacturing a magnetic recording medium according to claim 2, wherein
the flowing state non-magnetic material deposition step comprises a cured state non-magnetic material deposition substep of using a thermoplastic resin having a softening temperature of 50° C. or higher and 300° C. or lower as the non-magnetic material to deposit the non-magnetic material in cured state at a temperature lower than the softening temperature on the surface of the object to be processed, and a non-magnetic material fluidization substep of heating the non-magnetic material at a temperature higher than the softening temperature and 300° C. or lower so as to fluidize the non-magnetic material; and
the non-magnetic material curing step cools the non-magnetic material at a temperature lower than the softening temperature so as to cure the non-magnetic material.

8. The method for manufacturing a magnetic recording medium according to claim 2, wherein
the flowing state non-magnetic material deposition step uses a thermosetting resin having a curing temperature of 50° C. or higher and 300° C. or lower as the non-magnetic material to deposit the non-magnetic material in flowing state at a temperature lower than the curing temperature on the surface of the object to be processed; and
the non-magnetic material curing step heats the non-magnetic material at a temperature higher than the curing temperature and 300° C. or lower so as to cure the non-magnetic material.

9. The method for manufacturing a magnetic recording medium according to claim 2, wherein
the flowing state non-magnetic material deposition step uses a radiation curable resin as the non-magnetic material to deposit the non-magnetic material in a flowing state on the surface of the object to be processed; and
the non-magnetic material curing step radiates radiation so as to cure the non-magnetic material.

10. The method for manufacturing a magnetic recording medium according to claim 2, wherein
the flowing state non-magnetic material deposition step rotates the object to be processed around an axis approximately perpendicular to the surface of the object to be processed while the object to be processed on which the non-magnetic material in the flowing state is deposited is approximately horizontally held.

11. The method for manufacturing a magnetic recording medium according to claim 2, wherein
a flattening step of removing an excessive non-magnetic material so as to flatten the surface of the object to be processed is provided after the non-magnetic material curing step.

12. The method for manufacturing a magnetic recording medium according to claim 10, wherein
a flattening step of removing an excessive non-magnetic material so as to flatten the surface of the object to be processed is provided after the non-magnetic material curing step.

13. The method for manufacturing a magnetic recording medium according to claim 1, wherein the method comprising:
a non-magnetic material deposition step of depositing the non-magnetic material on the surface of the object to be processed including the recording layer formed in the concavo-convex pattern over the substrate so as to fill the concave portion of the concavo-convex pattern with the non-magnetic material; a fluid material deposition step of depositing a fluid material on a surface of the non-magnetic material; and a flattening step of removing the fluid material and an excessive non-magnetic material so as to flatten the surface of the object to be processed.

14. The method for manufacturing a magnetic recording medium according to claim 11, wherein
the flattening step employs a dry etching technique.

15. The method for manufacturing a magnetic recording medium according to claim 12, wherein
the flattening step employs a dry etching technique.

16. The method for manufacturing a magnetic recording medium according to claim 13, wherein
the flattening step employs a dry etching technique.

17. A magnetic recording medium comprising a recording layer formed in a predetermined concavo-convex pattern over a substrate, a concave portion of the concavo-convex pattern being filled with a non-magnetic material, wherein
the non-magnetic material contains at least one of indium and bismuth.
